(19) United States
(12) Patent Application Publication
(10) Pub. No.: US 2015/0035978 A1
(43) Pub. Date: Feb. 5, 2015

(54) Software Enabled Method for Deterrence of Child Abduction

(71) Applicant: John Dennis Johnston, La Quinta, CA (US)

(72) Inventor: John Dennis Johnston, La Quinta, CA (US)

(21) Appl. No.: 14/449,055

(22) Filed: Jul. 31, 2014

Related U.S. Application Data
(60) Provisional application No. 61/860,810, filed on Jul. 31, 2013.

(51) Int. Cl. G08B 21/02; H04N 7/18; G08B 15/00

(52) U.S. Cl. CPC G08B 21/0269; G08B 15/00; H04N 7/188
USPC 348/143; 340/539.13

(57) ABSTRACT

An abduction deterrent and user tracking system is provided which employs software configured to run on a portable computing device which has a display, a digital camera, wireless communication, and GPS locator. The software enables the portable computing device to provide identified parties with the subscribing user's terrestrial location and if available a real time digital photo taken by the user during an alarm initiated by the user in reaction to a perceived threat.

This application is claims the benefit of provisional application No. 61/860810 filed on Jul. 31, 2013, which is incorporated herein by this reference thereto.

### FIELD OF THE INVENTION

The disclosed device relates to a smartphone-enabled method for child protection. More specifically, it relates to an application adapted for operating on a portable computing device having wireless communication and a display such as a camera-enabled smartphone or pad computer, or eyewear. The system is configured to act as a deterrence for predatory behavior by individuals toward children and to provide updates to a child's parents or guardians as to their condition and/or location in the event such actions by a perpetrator against the child are not initially deterred.

### BACKGROUND OF THE INVENTION

The use and uses of digital media devices such as cell phones, smartphone devices, pad computers, and digital cameras, as well as eyewear which is coming of age under the GOOGLE GLASS concept, has increased rapidly as their technology and functionality has expanded. Their use and deployment has especially increased since such digital media devices have included digital cameras with onboard memory. The abilities of cell phones, smartphones, and other small computing devices have evolved greatly beyond the original single-function communication device for the spoken word. In recent years, cell phones have become small portable computing devices better known as smartphones, with onboard cameras, video screens, wireless communication, and having software and memory enabling the capturing and transmission of video and photos and editing thereof. Additional enhancements to wireless devices such as smartphones, pad computers, eyewear and similar camera-enabled wireless devices in recent years has included high energy batteries and onboard global positioning or GPS abilities, and the miniaturization of massive amounts of electronic memory.

With video, audio, and location capturing capabilities of most such portable digital media devices, as well as the advent of a multitude social applications for sharing video and data collected by smartphones and other wireless devices and the like, consumers continue to discover ever expanding uses for these digital media devices,be they smartphone devices, or pad computers, wireless-enabled digital cameras or eyewear having cameras and wireless communications. Thus,the hand-held cell phone has morphed into computerized smartphones and pad computers and other wireless communicating devices with substantial data and video capture and wireless transmission abilities, as well as location assessment capabilities.

Concurrently, a serious societal problem has continued to grow and plague children and easily-threatened individuals and their families, such as the predatory behavior by ill-willed adults and other persons toward children and adolescents or even other adults of lesser physical stature, such as women. While such demented behavior toward children by adults has existed through time, with the advent of modern news dissemination over cable news, satellite, and over the internet, both parents and children are becoming acutely more aware of it.

However, to date, other than the occasional grainy security camera capturing such predatory behavior by adults toward children and other adults, there has been little technological advancement to deter adults from preying on children and adolescents for ill-willed purposes such as kidnapping. Neither has there been provided a system to empower such susceptible children and adults, to help themselves avoid or be rescued when they are victims of actual or potential predatory behavior.

As such, there exists an unmet need for a portable and easily enabled system to both deter the initial predatory actions by adults toward children and other individuals, such as kidnapping. Such a system should endeavor to warn the adult with ill intentions in a manner allowing them to passively ascertain their current actions are being captured and/or watched by third parties, which is a well known deterrent to such behavior.

In the event such ill behavior is unfortunately not deterred or prevented by the system, such a system should provide a means for communicating real time location updates of the affected child or individual during transport, during a kidnapping or the like, or during their detention by those of ill will, to allow parents, relatives, and law enforcement to intervene. Ideally, this ongoing update would cause rescue or release quite likely, before the elapse of sufficient time where harm could come to the child or individual.

Finally, such a system should be operational or enabled for operative communication on a small computing device having photographic capturing and storage abilities and wireless communication ability such as a smartphone, digital camera, Pad computer, eyewear, or other small computing devices with displays which are adapted for wireless communication such as through the employment of cell-tower communication, WiFi or Bluetooth. Such will enable the wireless video capturing device, adapted to run the system herein, to provide for the real time communication of one or a combination of GPS locations and photos or videos depicting the perpetrating person perceived by the child as someone with ill intent. Ideally, such a system should also provide ongoing location information of the child or individual in trouble until deactivated.

In this respect, before explaining at least one embodiment of the smartphone enabled software driven system herein in detail, it is to be understood that the invention is not limited in its application to the details of construction and to the arrangement of the components set forth in the following description or illustrated in the drawings nor the steps outlined in the specification. The disclosed system for capture and broadcast of digital video of perpetrators of crimes toward children and individuals and/or geographic location information herein, is capable of other embodiments and of being practiced and carried out in various ways as those skilled in the art will readily ascertain once educated in the novel device and method of this application.

Also, it is to be understood that the phraseology and terminology employed herein are for the purpose of description and should not be regarded as limiting in any manner. As such, those skilled in the art will appreciate that the conception upon which this disclosure of the software enabled system herein, is based may readily be utilized as a basis for designing other methods and systems for carrying out the several purposes of the method for identification and location tracking disclosed herein. It is important, therefore, that the claims be regarded as including such equivalent construction insofar as they do not depart from the spirit and scope of the present invention.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of the system herein disclosed and described to provide a solution to the shortcomings in prior art and achieve the above noted goals through the provision of a computer enabled software driven system using a smartphone's media capture and sharing ability.

It is a further object to provide children with a defense against unrequested approaches from adults perceived by the child as a stranger or having ill intentions.

It is yet another objet of the system herein to provide transmission of video identifying adults and/or their vehicle in the event a child is abducted.

It is a further object of the invention herein, to provide real time locational tracking using a device in a stealth mode to provide parents and authorities with an ability to find an abducted child in real time.

These and other objects features, and advantages of the present invention, as well as the advantages thereof over existing prior art, which will become apparent from the description to follow, are accomplished by the system and method described in this specification and hereinafter described in the following detailed description which fully discloses the invention, but should not be considered as placing limitations thereon.

### SUMMARY OF THE INVENTION

The disclosed system or method herein is operational upon a computing device with wireless RF broadcast ability, and photo or video capture ability, such as a smartphone or similar video and wireless enabled device. Employing software adapted to run on the smartphone or portable computing device, the system herein is rendered portable and easily enabled for a child to carry on their person to thereby provide a means for deterring the completion of the initial predatory actions by adults, toward children, thereby preventing a kidnapping.

The system running on a portable computing device, such as a smartphone, empowers a child to use it as protection from an adult having ill intentions toward the child. When used, the device enabled by the software herein, enables the adult with ill intent, prior to completion of abduction of the child, to ascertain they are being watched and identifying information has already been sent out of their reach. The threat of being identified and held accountable is a well known deterrent to such behavior by potential predators.

Further, by employing the software driven system on a portable device with video, cellular, and GPS capabilities, in the unfortunate event the adult is not initially deterred when it is discerned their image has been recorded, and abducts a child, the system can be enabled to provide real time location updates. Through such ongoing updates, a current geographic position of an abducted child during transport in a kidnapping or the like, can be transmitted in real time. The real time location transmission along with communicated video and/or photo depicting the adult predator and/or their vehicle enables parents and law enforcement to find the child and intervene before the elapse of time sufficient where harm can come to the child.

The system employs software adapted to run on a smartphone or another microprocessor-enabled electronic device with cell tower communication and video and GPS location transmission ability, to engage in steps to deter and/or identify child predators. It is configured to allow the child to input a first command, to capture and immediately transmit photos or videos showing the person perceived by the child as someone with ill intent. Should that not be the case, the child in a subsequent input command, may direct the software to call off an alarm.

However, should the child be correct and abducted, in addition to the transmission of identifying video, if not then immediately disarmed, the smartphone or electronic device running the system herein, will transmit ongoing location information of the child so as to enable law enforcement to find the child.

In operation, the software running on a smartphone type device, will allow the user to designate one or a plurality of remote-located individuals who will receive a video and message from the child-carried smartphone or device, with essentially a “mug shot” of the individual the child perceives as someone they don't trust or feel might harm them. The video and a pre-written message will be transmitted over the wireless or cellular system and arrive to one or multiple relatives who are most likely to immediately react to the received photo message.

The remote persons receiving the messages can be the child's parents, guardians, siblings, or secondary relatives or even a security service if such is enabled. Thus, no matter the outcome, the perpetrator's image will have been taken and transmitted out of reach to multiple remote locations to people who will react rather than ignore the incoming message.

In use, the software will present a user-chooseable button or icon which when touched, will “arm” the device and either start taking video, or get ready to take video. A second button or icon is then presented on the video screen of the device, to enable the child to transmit video being taken, or previously taken, of the perpetrator, along with an emergency message, and/or a GPS current location, to the predesignated parties.

It is preferred that when video or a photo is taken, that when the smartphone's camera takes photos or video, that the flash is activated so that the ill-intending adult will see it. In this fashion an uninvited stranger will ascertain immediately that their image has been captured having the effect of letting that person know their identity can be found out. It has been found that the fear of being identified and caught is an excellent deterrent to someone who has not yet committed a crime.

Concurrently, the captured photo or video is immediately transmitted to the plurality of chosen parties, before the stranger approaching can do anything to stop it, and thus their image is already in the hands of potential identifiers. Additionally, it is preferred that GPS information is also transmitted.

Because, as noted, some ill-willed strangers may not be deterred by the knowledge their image has been transmitted, the child is provided with a third command button to choose. This third option places the software and the phone in a stealth mode, where the video screen of the device, looks normal for a smartphone which is not messaging or transmitting. However in fact, the system herein running in a background program not visible to a viewer, is continuously broadcasting a GPS location, and/or audio and video being captured at the moment. In the stealth mode, the perpetrator will not know their location and movements and/or ongoing audio and video are being transmitted to one or a plurality of remote locations designated in advance and will more possibly speak or do some act to provide links to their identity and/or location.

In a fourth chooseable option, the child is also presented with a cancel command, to cancel the operation of the software to notify preselected parties. This is done when the child realizes there is not a threat and will return the device to the first command screen to allow arming of the device.

Additionally, in a very serious scenario when a child or other person employing the system herein is forced into a vehicle, as long as that person has possession of the smartphone and the system has been armed, other actions can occur. First, once the vehicle reaches a threshold speed, for example over 10 mph, a “moving GPS text” will be sent to the recipient list and updated with current locations of that vehicle—as it travels. For example, if the vehicle is heading north on a particular freeway, the app will state how fast the vehicle is moving, and if or when it exits that freeway. All such information will be transmitted in real time.

### BRIEF DESCRIPTION OF DRAWING FIGURES

The accompanying drawings, which are incorporated herein and form a part of the specification, illustrate some, but not the only or exclusive, examples of steps, embodiments and/or features of the software enabled system herein. It is intended that the embodiments and figures disclosed herein are to be considered illustrative of the system herein, rather than limiting. In the drawings:

FIG. 1 depicts the first command key presented to the child or adult user of the system herein, as would display on the video display of a smartphone, wireless-enabled eyewear or a similar wireless communicating device.

FIG. 2 depicts second, third, and fourth, command keys presented to the subscribing user of the system herein, as would display on the video display of a smartphone, wireless eyewear having a display, or a like device to enable the actions of the system herein.

FIG. 3 depicts a typical diversion graphic the system positions on the home page of the smartphone or other device employed for the system herein.

FIG. 4 depicts a flow chart showing preferred and optional steps of the system herein.

### DETAILED DESCRIPTION OF THE INVENTION

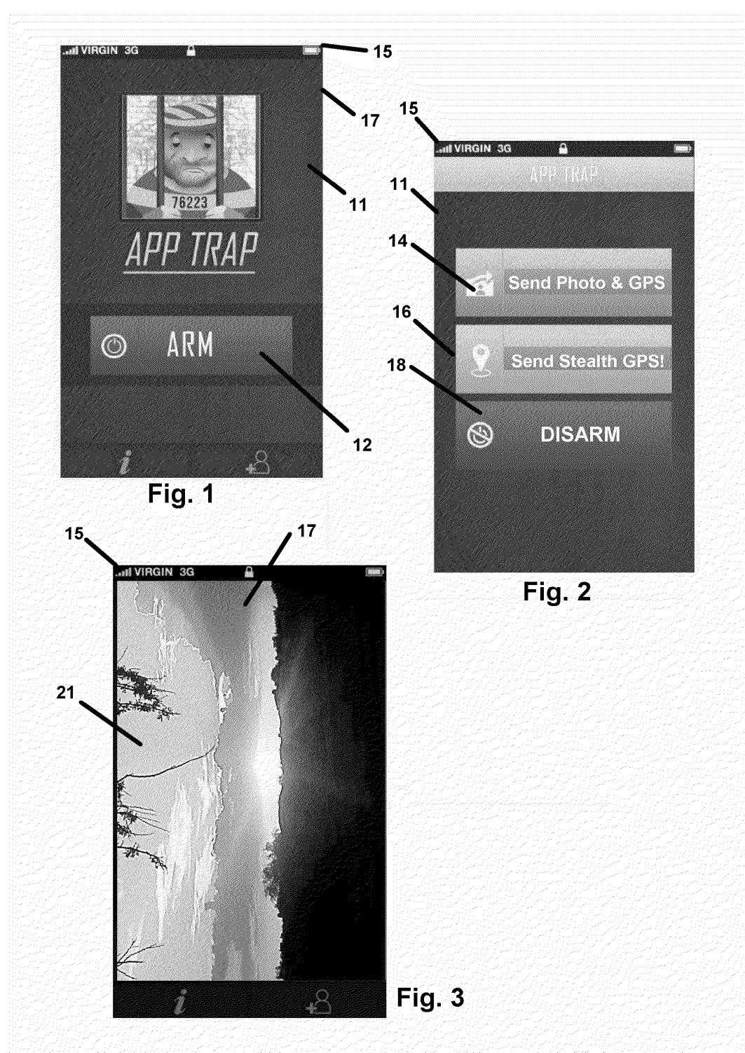

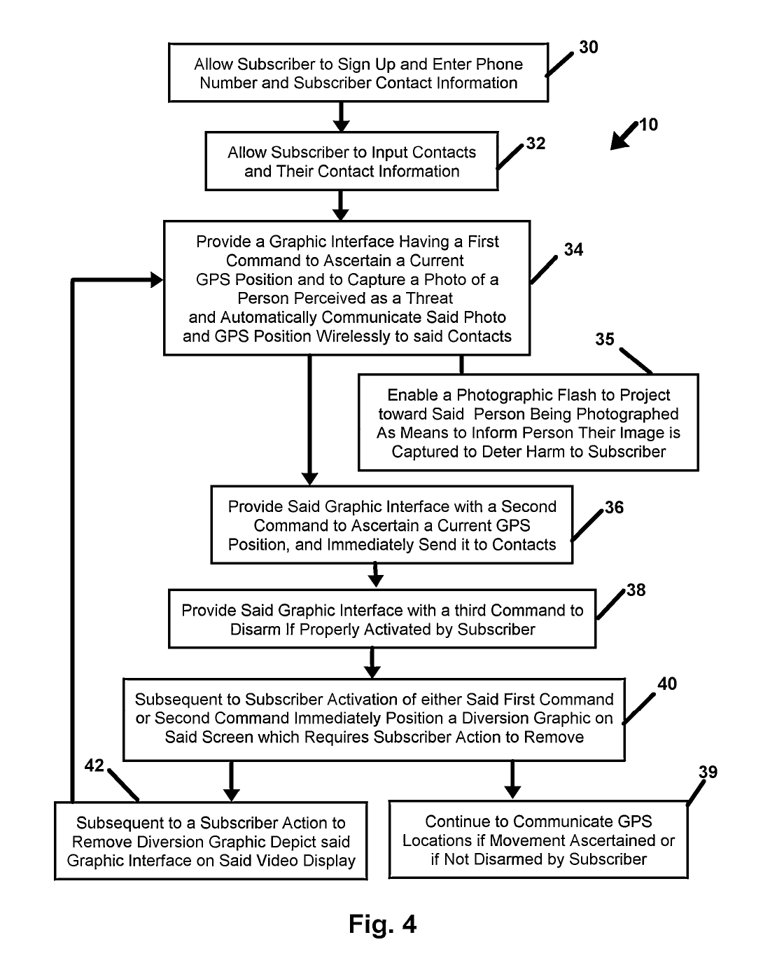

Now referring to drawings in FIGS. 1-4, wherein similar components, depictions, and steps, are identified by like reference numerals, there is seen one mode of the provision of the system 10, a computer graphic interface 11 configured for the user to input commands to initiate the automatic actions of the system 10 herein.

As noted above, the system 10, is configured to allow the user such as a child to input a first command to arm 12 the system 10 which is enabled by software running on a portable computing device having digital photography capabilities and wireless communication capability, such as a smartphone, pad computer, digital camera or eyewear. The system 10 is enabled by software adapted to run on the portable computing device 15 of any portable device which also has GPS, a digital camera and wireless communications capability, which currently includes smartphones, cellular phones, digital cameras, eyewear such as that used with GOOGLE GLASS, and similar products, and even specialized devices having such components configured simply for the system 10 herein.

The graphic interface 11 as such would be enabled by software adapted to generate the screens of the graphic interface 11, on a display 17, in FIGS. 1-3, and to act to activate the system 10 when the user employs one of the command inputs to initiate the desired action by the system 10 such as the virtual buttons shown in FIGS. 1-2. Thus, the system 10 may be enabled by software adapted to run on the portable computing device such as a smartphone, known as an “app” or it could be loaded into operative memory of a digital camera or into eyewear having the noted computing component and other components above.

Alternatively, the system 10 may operate when loaded into read only or writeable electronic memory of an electronic component specially constructed to run on the system 10 herein such as a pendant in a miniaturized version.

Initially, the graphic interface 11 will render a user activated command to arm 12 the system 10. However, alternatively, the system 10 could just be armed at all times. If the child or adult subscriber 10 to the system 11 ascertains the threat causing them to arm the system 10 has not ceased, the second command buttons of the graphic interface 11, allow the subscribing user to initiate the device to command the system 10 to wirelessly communicate either a digital photo taken by the user along with GPS geographic location coordinates 14, or simply the GPS geographic location coordinates 16 if the subscribing user does not have time to use the portable device to take the digital photo.

If the command to send a digital photo and GPS coordinates 14 is initiated, the digital photo may be taken using the normal buttons and inputs on the electronic device 15, or touching the button 14 to send the digital photo and GPS coordinates can cause the digital photo to be taken and concurrently wirelessly communicate with the GPS coordinates which are continuously monitored by the onboard GPS system.

Subsequent to either transmission of information, the system 10 can be programmed to subsequently automatically communicate GPS geographic location coordinates continuously, or every few seconds, or every few minutes to save electrical power. This subsequent ongoing location communication can be handled by the system 10 in a stealth mode where the graphic interface 11 of FIGS. 1 and 2 is not depicted but a decoy graphic 21 such as in FIG. 3, which appears like a normal photo, such as a sunset, is seen when the electronic device has its video display energized.

Such will continue to update the subscribing user's location to the contacts for the subscribing user, without alerting the suspected perpetrator that the system 10 continues to communicate the subscribing user's location. During the stealth mode when the wireless communication from the electronic device is continuously broadcasting a GPS location, it may concurrently broadcast audio and/or ongoing video being captured electronically at the moment.

The decoy graphic 21 would automatically appear on the display of the employed device once any communication is initiated by the subscribing user by interacting with the displayed graphic interfaces 11 such as in FIGS. 1-2. It is this stealth mode which acts as a means to prevent the perpetrator from ascertaining the system 10 is communicating digital information so the perpetrator is not alarmed and does not throw the device, such as the smartphone 15, away.

In situations where the system 10 is armed by the employment by the user of the virutal button or other input to arm 12 the system 10, in the event the subscribing user determines there is no threat, or the threat has ceased, the user in a subsequent input command, either while the graphic interface 11 shown in FIG. 2 is displayed, or by acting to input the secret command to remove the decoy graphic 21 to initiate the second screen of the graphic display, may input the command to disarm 18 and have the software running the system 10 call off an alarm.

Outlining the steps of the system 10 enabled by the software running on the computing device having the image capturing, GPS, and wireless communication ability, once the system 10 software is downloaded or running on the user computing device, the software will initiate communications with the service provider server and provide input screens on the graphic interface to allow the subscriber to sign up and enter their phone number and to enter contact information concerning the subscribing user 30.

The system 10 will also provide input screens to enable the subscribing user to input contacts and their respective contact information 32. These contacts and their contact information related to the subscribing user and the identified electronic device are saved in an electronic database on the server or computers of the service provider. Once the system 10 is activated by the subscribing user, one or a plurality of the contacts relating to the subscribing user are provided the transmitted data and/or imagery.

In operation, once user and contact input is completed, the system 10 employs the software to generate and provide a graphic interface 11 which may include the arming command to arm the system 10 and to either having a first command input 34 to ascertain a current GPS position and to communicate a photo of a person perceived as a threat and the discerned GPS position wirelessly to the contacts related to the subscribing user and device.

If the system 10 uses the first command input 34 or a separate input to capture the image to be communicated, the system 10 may include the step of automatically enabling a photographic flash 35 of the device running the system 10, to project toward the person being photographed as a means to visually warn and passively inform that person their image is captured as a means to deter them from further proceeding or doing harm to the subscribing user.

Also provided with the graphic interface 11 is a second command input 36 for the user to command the system 10 to simply ascertain a current GPS position which will be immediately sent to the contacts entered by and relating to the subscribing user.

Additionally, preferably provided in the system is the provision of a graphic interface with a screen or third command 38 which the subscribing user may activate to disarm the system 10 if properly activated by the subscribing user. This can require a certain timing or number of finger contacts or taps to the screen, or another user-known secret input, or simply be activated when touched. During the diversion graphic provision, the system 10 can also be configured to continue to communicate GPS locations over time or if movement is sensed or otherwise 39.

In all modes of operation of the system 11, it is preferred if the system, subsequent to subscriber activation of either the first command or second command to immediately enter a mode where the diversion graphic is displayed 40 on the display screen as in FIG. 3. Further, once displayed it is preferable that a special input by the subscribing user be required to remove the diversion graphic 42 from the display screen such as tapping on it three times, or timing a certain number and spacing of taps to the diversion graphic which also concurrently operates as a graphic interface screen awaiting the secret input.

Finally, subsequent to a subscriber command correctly input to the graphic interface or device, to remove the diversion graphic, the graphic interface 11 would start again to display one or a plurality of the command buttons noted above for restarting the system 11 when armed.

As noted above, while the deterrent system of the present invention has been described herein with reference to particular embodiments thereof and steps in the method of employment, a latitude of modifications, various changes and substitutions are intended in the foregoing disclosures. It will therefor be appreciated that in some instances some features or steps in formation of the system herein could be employed with some features or steps, without a corresponding use of other features without departing from the scope of the invention as set forth in the following claims. Alternatively additional steps might be added. All such changes, alternations and modifications as would occur to those skilled in the art, are considered to be within the scope of this invention as broadly defined in the appended claims.

What is claimed is:

1. An abduction deterrent and user tracking system employing software configured to run on a portable computing device which has a display, a digital camera, wireless communication, and a means to determine a GPS terrestrial location thereof, comprising the steps of:
providing a graphic interface to a subscriber configured for input by said subscriber of subscriber contact information;
storing said subscriber contact information in electronic memory of a computer or server operated by a system provider;
providing said graphic interface to said subscriber configured for input of party contact information for parties to be contacted during an alarm;
providing said graphic interface which is renderable on said display of said portable computing device, having a first command and having a second command, either of which are configured for an activation by an action of said subscriber;
upon a said activation of said first command, employing said wireless communication to transmit a first command communication of a digital image captured by said digital camera, and a said GPS terrestrial location, over a wireless network to said server operated by said system provider;
upon a said activation of said second command, employing said wireless communication to transmit a second command communication of solely a current said GPS terrestrial location over said wireless network to said server operated by said system provider;
upon a receipt of either of a said first command communication or a said second command communication, communicating a said alarm to said parties to be contacted; and
providing said parties to be contacted information relating to one or both of said current GPS terrestrial location or said digital image, whereby said parties to be contacted may ascertain a location of said subscribing user and if communicated in said wireless communication, a depiction of said digital image.

2. The abduction deterrent and user tracking system of claim 1, additionally comprising:
subsequent to a said activation of either said first command or said second command, communicating a decoy image to said computing device which is immediately rendered by default on said display thereof, in place of said graphic interface, thereby providing a means to prevent a third party from viewing the graphic display.

3. The abduction deterrent and user tracking system of claim 2, additionally comprising:
configuring said decoy image to re-display said graphic interface upon sequential number of contacts the by a finger of said subscriber with said decoy image.

4. The abduction deterrent and user tracking system of claim 1, additionally comprising:
upon a said activation of said first command, causing said digital camera to capture said digital image which is then included in said first command communication.

5. The abduction deterrent and user tracking system of claim 2, additionally comprising:
upon a said activation of said first command, causing said digital camera to capture said digital image which is then included in said first command communication.

6. The abduction deterrent and user tracking system of claim 3, additionally comprising:
upon a said activation of said first command, causing said digital camera to capture said digital image which is then included in said first command communication.

7. The abduction deterrent and user tracking system of claim 4, additionally comprising:
upon a said activation of said first command, causing a flash illumination of a flash operating in combination with said digital camera by default, whereby said flash illumination is a passive means to inform a third party their image is digitally captured.

8. The abduction deterrent and user tracking system of claim 5, additionally comprising:
upon a said activation of said first command, causing a flash illumination of a flash operating in combination with said digital camera by default, whereby said flash illumination is a passive means to inform a third party their image is digitally captured.

9. The abduction deterrent and user tracking system of claim 6, additionally comprising:
upon a said activation of said first command, causing a flash illumination of a flash operating in combination with said digital camera by default, whereby said flash illumination is a passive means to inform a third party their image is digitally captured.

10. The abduction deterrent and user tracking system of claim 1, additionally comprising:
prior to providing said graphic interface which is renderable on said display of said portable computing device, having a first command and having a second command, requiring said subscriber to first take an action to activate the tracking system.

11. The abduction deterrent and user tracking system of claim 1, additionally comprising:
prior to providing said graphic interface which is renderable on said display of said portable computing device, having a first command and having a second command, requiring said subscriber to first take an action to activate the tracking system.
